(19) United States
(12) Patent Application Publication
(10) Pub. No.: US 2023/0026951 A1
(43) Pub. Date: Jan. 26, 2023

(54) Speckle Reduction For An Additive Printing System

(71) Applicant: Seurat Technologies, Inc., Wilmington, MA (US)

(72) Inventors: Jeffrey Jarboe, Wakefield, MA (US); Andrew J. Bayramian, Marblehead, MA (US); James A. DeMuth, Woburn, MA (US); Francis L. Leard, Sudbury, MA (US); Yiyu Shen, Tewksbury, MA (US)

(21) Appl. No.: 17/874,055

(22) Filed: Jul. 26, 2022

Related U.S. Application Data
(60) Provisional application No. 63/225,742, filed on Jul. 26, 2021.

(51) Int. Cl. B22F 12/43; B22F 12/45; B23K 26/06; B33Y 10/00

(52) U.S. Cl. CPC B22F 12/43; B22F 12/45; B23K 26/0648; B33Y 10/00

(57) ABSTRACT

An additive manufacturing system can include at least one laser source and a speckle reduction system that receives light from the at least one laser source. The speckle reduction system provides laser light to an optical homogenizer that increases uniformity of laser light and can provide the light to an area patterning system.

### RELATED APPLICATION

The present disclosure is part of a non-provisional patent application claiming the priority benefit of U.S. Patent Application No. 63/225,742, filed on Jul. 26, 2021, which is incorporated by reference in its entirety.

### TECHNICAL FIELD

The present disclosure generally relates to additive manufacturing systems that provide for use of high power solid state or diode lasers and diffractive optical homogenizers. More particularly, laser speckle reduction techniques suitable for high temporal coherence and high peak power laser systems are described.

### BACKGROUND

High power laser systems with light able to operate at high fluence for long durations are useful for additive manufacturing and other applications that can benefit from use of high energy lasers. Solid state laser systems are capable of high peak power and can serve as a platform for many additive manufacturing applications. Unfortunately, high peak power solid-state laser systems able to produce uniform intensity distribution across a desired beam shape can be difficult. Scaling energy or long term operation can be difficult without a uniform intensity distribution that maintains precise process control and minimizes peak.

### BRIEF DESCRIPTION OF THE DRAWINGS

Non-limiting and non-exhaustive embodiments of the present disclosure are described with reference to the following figures, wherein like reference numerals refer to like parts throughout the various figures unless otherwise specified.

FIG. 1A illustrates a speckle reduction system for high power lasers;

FIG. 1B illustrates speckle reduction using multiple lasers combined in a common fiber;

FIG. 1C illustrates speckle reduction using fiber splitters of differing length;

FIG. 1D illustrates speckle reduction using an RF modulator that adds spectral bandwidth to a laser pulse;

FIG. 1E illustrates speckle reduction using large area mode fibers that increase number of modes;

FIG. 1F illustrates speckle reduction using an actuator to cause displacement of the multimode fiber;

FIG. 1G illustrates speckle reduction using various mechanisms and optics to change speckle pattern.

FIG. 2 illustrates a block diagram of a high fluence light valve based additive manufacturing system supporting a speckle reduction system;

FIG. 3 illustrates a high fluence additive manufacturing system with a speckle reduction system;

FIG. 4 illustrates another embodiment of a high fluence additive manufacturing system with a speckle reduction system; and

FIG. 5 illustrates another embodiment of a high fluence additive manufacturing which incorporates a switchyard systems and includes a speckle reduction system.

### DETAILED DESCRIPTION

In the following description, reference is made to the accompanying drawings that form a part thereof, and in which is shown by way of illustrating specific exemplary embodiments in which the disclosure may be practiced. These embodiments are described in sufficient detail to enable those skilled in the art to practice the concepts disclosed herein, and it is to be understood that modifications to the various disclosed embodiments may be made, and other embodiments may be utilized, without departing from the scope of the present disclosure. The following detailed description is, therefore, not to be taken in a limiting sense.

In the following disclosure, an additive manufacturing system can include at least one laser source and a speckle reduction system that receives light from the at least one laser source. The speckle reduction system provides laser light to an optical homogenizer that increases uniformity of laser light and can provide the light to an area patterning system.

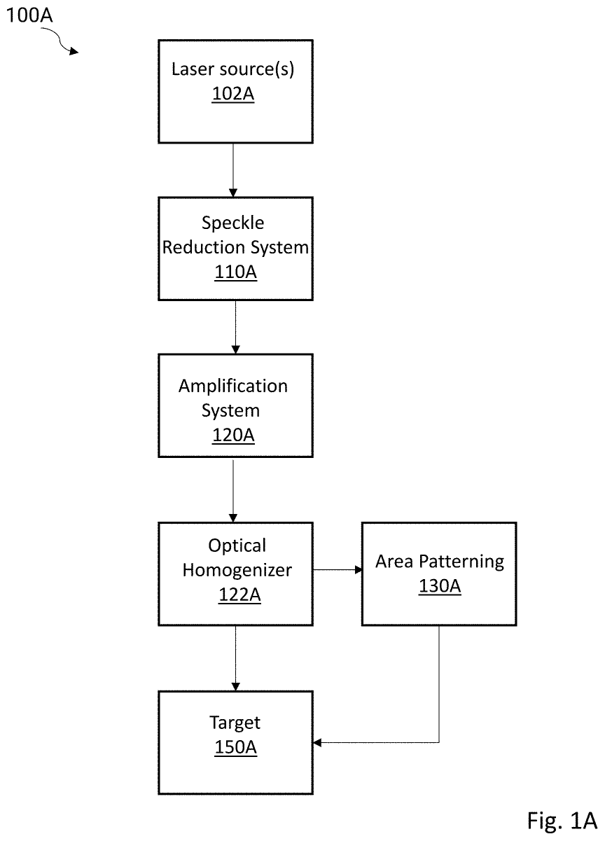

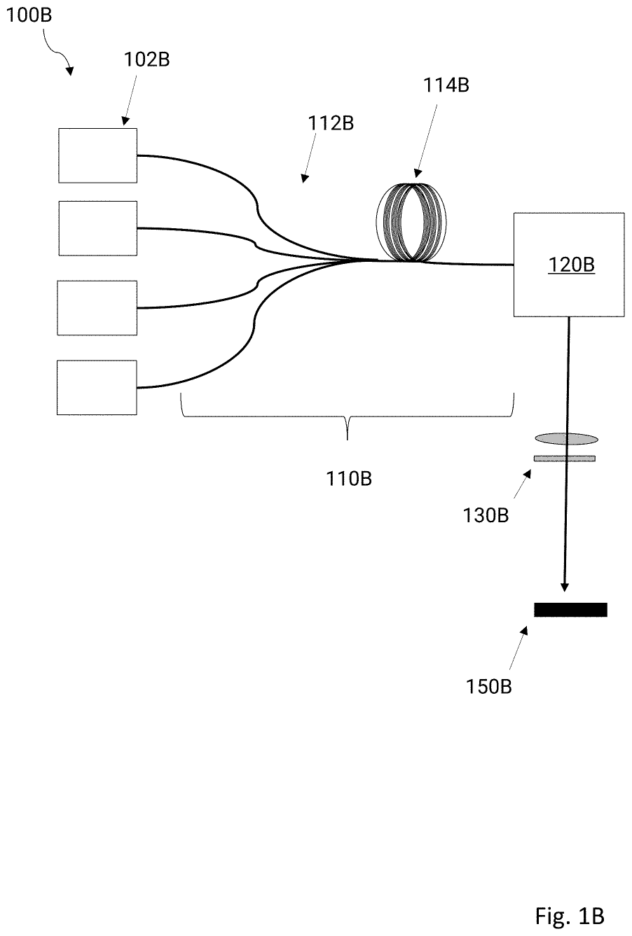

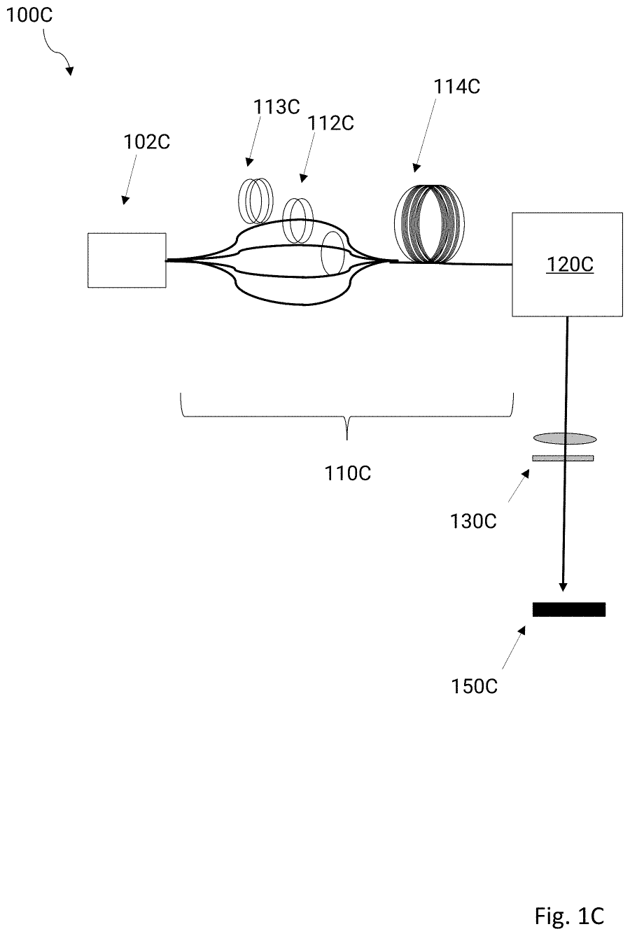

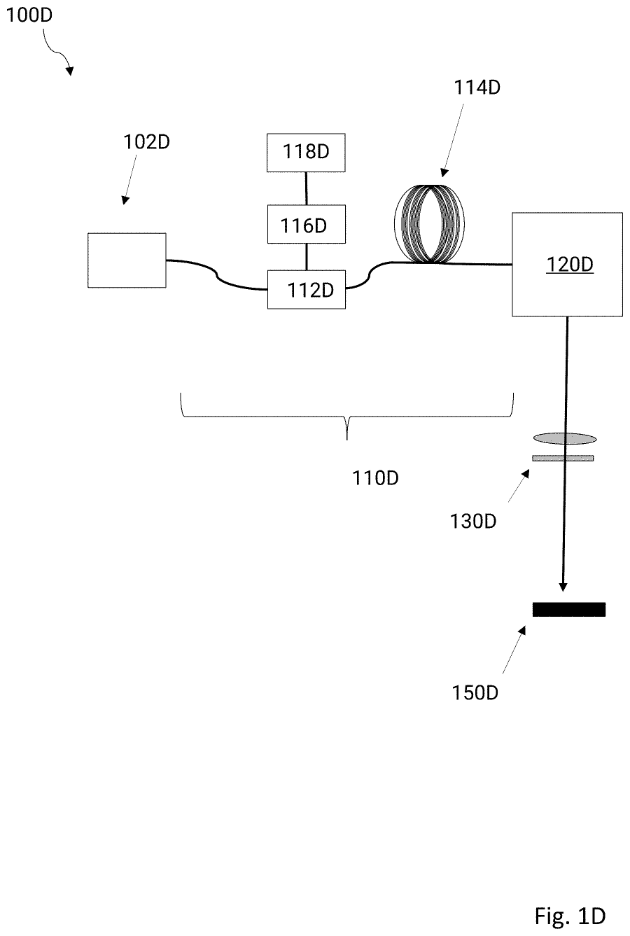

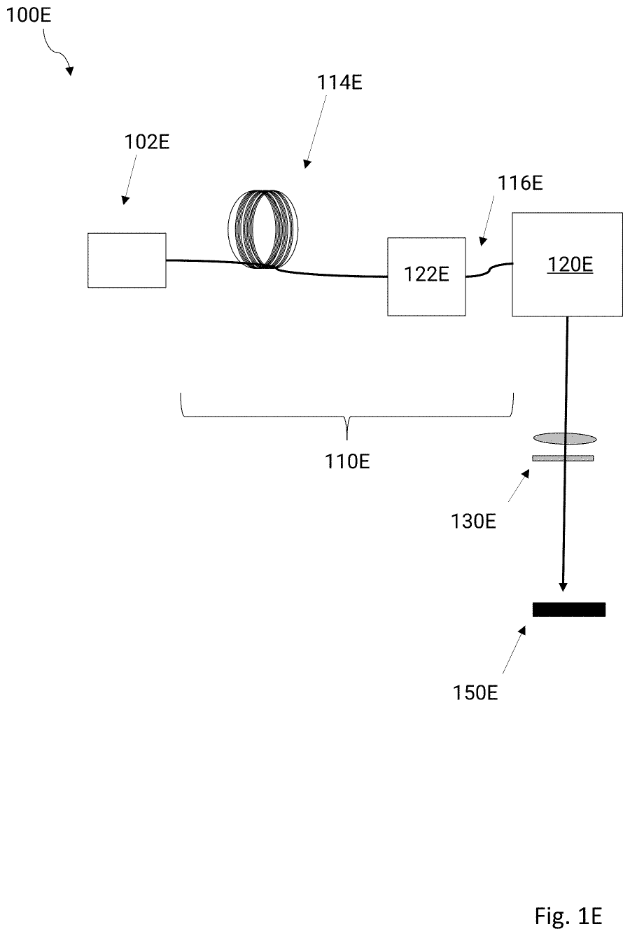

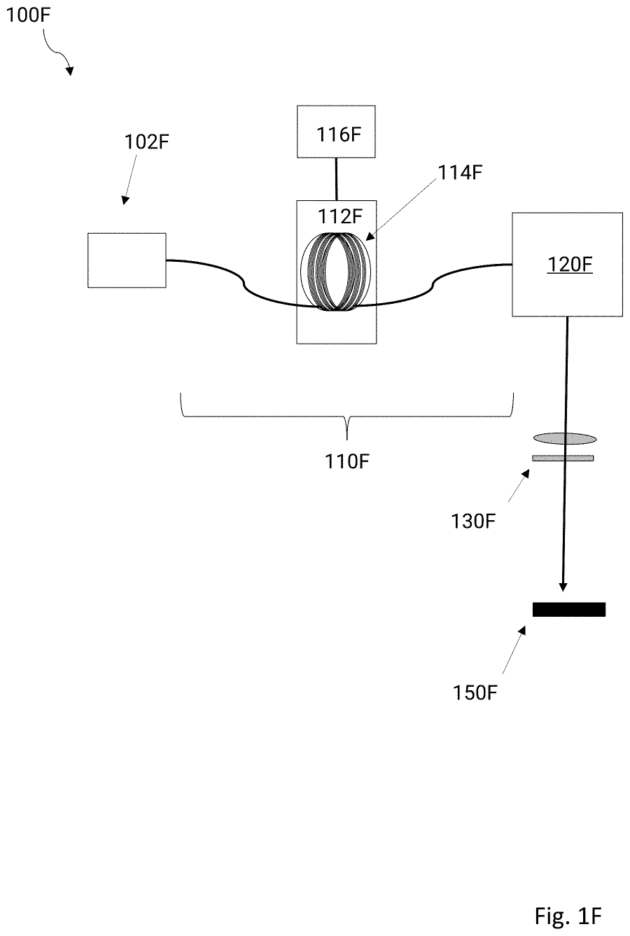

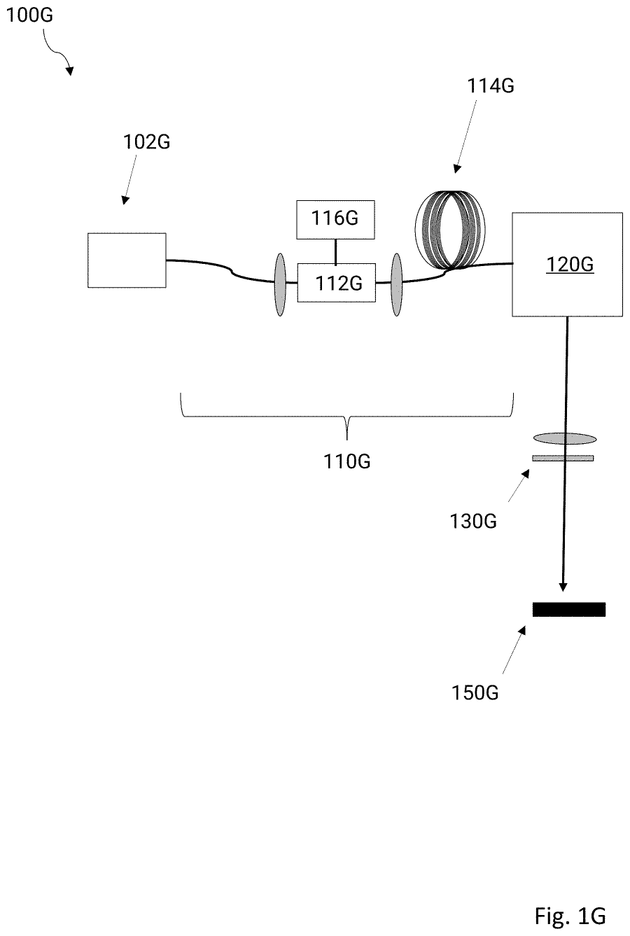

FIG. 1A illustrates a speckle reduction system 100A for high power lasers. Laser source or sources 102A can include but are not limited to diode or solid state lasers. Laser beam(s) can be directed into a speckle reduction system 110A and amplified using amplifier system 120A. The amplified energy laser beams can be directed through an optical homogenizer 122A to increase laser beam uniformity and immediately or through relay optics directed against a target 150A. In some embodiments, the laser beam can optionally be patterned before direction against the target 150A, using an area patterning system 130 to provide a two-dimensional patterned beam useful for two-dimensional additive manufacturing.

Laser sources 102A can include wide range of lasers of various wavelengths can used in combination with the described speckle reduction system 110A. In some embodiments, possible laser types include, but are not limited to: Gas Lasers, Chemical Lasers, Dye Lasers, Metal Vapor Lasers, Solid State Lasers (e.g. fiber), Semiconductor (e.g. diode) Lasers, Free electron laser, Gas dynamic laser, “Nickel-like” Samarium laser, Raman laser, or Nuclear pumped laser.

A Gas Laser can include lasers such as a Helium-neon laser, Argon laser, Krypton laser, Xenon ion laser, Nitrogen laser, Carbon dioxide laser, Carbon monoxide laser or Excimer laser.

A Chemical laser can include lasers such as a Hydrogen fluoride laser, Deuterium fluoride laser, COIL (Chemical oxygen-iodine laser), or Agil (All gas-phase iodine laser).

A Metal Vapor Laser can include lasers such as a Helium-cadmium (HeCd) metal-vapor laser, Helium-mercury (HeHg) metal-vapor laser, Helium-selenium (HeSe) metal-vapor laser, Helium-silver (HeAg) metal-vapor laser, Strontium Vapor Laser, Neon-copper (NeCu) metal-vapor laser, Copper vapor laser, Gold vapor laser, or Manganese (Mn/MnCl₂) vapor laser. Rubidium or other alkali metal vapor lasers can also be used. A Solid State Laser can include lasers such as a Ruby laser, Nd:YAG laser, NdCrYAG laser, Er:YAG laser, Neodymium YLF (Nd:YLF) solid-state laser, Neodymium doped Yttrium orthovanadate(Nd:YVO₄) laser, Neodymium doped yttrium calcium oxoborateNd:YCa₄O(BO₃)³ or simply Nd:YCOB, Neodymium glass(Nd:Glass) laser, Titanium sapphire(Ti:sapphire) laser, Thulium YAG (Tm:YAG) laser, Ytterbium YAG (Yb:YAG) laser, Ytterbium:2O₃ (glass or ceramics) laser, Ytterbium doped glass laser (rod, plate/chip, and fiber), Holmium YAG (Ho:YAG) laser, Chromium ZnSe (Cr:ZnSe) laser, Cerium doped lithium strontium (or calcium)aluminum fluoride(Ce:LiSAF, Ce:LiCAF), Promethium 147 doped phosphate glass(147Pm⁺³:Glass) solid-state laser, Chromium doped chrysoberyl (alexandrite) laser, Erbium doped anderbium-ytterbium co-doped glass lasers, Trivalent uranium doped calcium fluoride (U:CaF₂) solid-state laser, Divalent samarium doped calcium fluoride(Sm:CaF₂) laser, or F-Center laser.

A Semiconductor Laser can include laser medium types such as GaN, InGaN, AlGaInP, AlGaAs, InGaAsP, GaInP, InGaAs, InGaAsO, GaInAsSb, lead salt, Vertical cavity surface emitting laser (VCSEL), Quantum cascade laser, Hybrid silicon laser, or combinations thereof.

The speckle reduction system 110A can include various embodiments. For example, speckle reduction using multiple lasers combined in a common fiber, using fiber splitters of differing length, using an RF modulator that adds spectral bandwidth to a laser pulse, or using large area mode fibers that increase number of modes is supported. Alternatively or in addition, speckle reduction using an actuator to cause displacement, or using various optical or acoustic deflectors or modifiers can be used.

Amplification system 120A can include one or more pre-amplifiers or amplifiers. In some embodiments, various preamplifiers or amplifiers are optionally used to provide high gain to the laser signal, while optical modulators and isolators can be distributed throughout the system to reduce or avoid optical damage, improve signal contrast, and prevent damage to lower energy portions of the system 100A. Optical modulators and isolators can include, but are not limited to Pockels cells, Faraday rotators, Faraday isolators, acousto-optic reflectors, or volume Bragg gratings. Pre-amplifier or amplifiers could be diode pumped or flash lamp pumped amplifiers and configured in single and/or multi-pass or cavity type architectures. As will be appreciated, the term pre-amplifier here is used to designate amplifiers which are not limited thermally (i.e. they are smaller) versus laser amplifiers (larger). Amplifiers will typically be positioned to be the final units in a amplification system 120A and will be the first modules susceptible to thermal damage, including but not limited to thermal fracture or excessive thermal lensing.

Laser pre-amplifiers can include single pass pre-amplifiers usable in systems not overly concerned with energy efficiency. For more energy efficient systems, multi-pass pre-amplifiers can be configured to extract much of the energy from each pre-amplifier before going to the next stage. The number of pre-amplifiers needed for a particular system is defined by system requirements and the stored energy/gain available in each amplifier module. Multi-pass pre-amplification can be accomplished through angular multiplexing or polarization switching (e.g. using waveplates or Faraday rotators).

Alternatively, pre-amplifiers can include cavity structures with a regenerative amplifier type configuration. While such cavity structures can limit the maximum pulse length due to typical mechanical considerations (length of cavity), in some embodiments “White cell” cavities can be used. A “White cell” is a multi-pass cavity architecture in which a small angular deviation is added to each pass. By providing an entrance and exit pathway, such a cavity can be designed to have extremely large number of passes between entrance and exit allowing for large gain and efficient use of the amplifier. One example of a White cell would be a confocal cavity with beams injected slightly off axis and mirrors tilted such that the reflections create a ring pattern on the mirror after many passes. By adjusting the injection and mirror angles the number of passes can be changed.

Amplifiers are also used to provide enough stored energy to meet system energy requirements, while supporting sufficient thermal management to enable operation at system required repetition rate whether they are diode or flashlamp pumped. Both thermal energy and laser energy generated during operation can be directed the heat transfer, heat engine, cooling system, and beam dump.

Amplifiers can be configured in single and/or multi-pass or cavity type architectures. Amplifiers can include single pass amplifiers usable in systems not overly concerned with energy efficiency. For more energy efficient systems, multi-pass amplifiers can be configured to extract much of the energy from each amplifier before going to the next stage. The number of amplifiers needed for a particular system is defined by system requirements and the stored energy/gain available in each amplifier module. Multipass pre-amplification can be accomplished through angular multiplexing, polarization switching (waveplates, Faraday rotators). Alternatively, amplifiers can include cavity structures with a regenerative amplifier type configuration. As discussed with respect to pre-amplifiers, amplifiers can be used for power amplification.

Optical homogenizers 122A can include controlled scattering homogenizers, also called beam shaping diffusers. In some embodiments, controlled scattering homogenizers provide highly defined phase surfaces that scatter the light in pre-defined angles and intensity ratios per angle using a diffractive optical element (DOE), a micro lens array, or broadband diffuser homogenizer. Diffractive diffusers are commonly monochromatic and work only at a particular wavelength. Advantageously, diffractive diffusers can have diffraction-limited edge sharpness and absolute angular accuracy due to their lithographic production process. This makes them especially useful for high fluence laser applications that require precise diffusion angles, such as laser industrial processing and additive manufacturing. Refractive diffusers, such as micro-lens arrays, can work at all wavelengths where the material is transparent, and have high efficiency. Broadband diffusers combine the advantages of the complete shaping freedom of diffractive diffusers with the polychromatism and high-efficiency of refractive diffusers. This is done by defining a surface that has both refractive and diffractive scattering of the light.

Area patterning 130A can be used to provide a laser capable of being directed against target 150A as a patterned tile or two-dimensional area. In some embodiments, light modulators can be used. For example, a transmissive or reflective spatial light modulator (SLM), also known as a light valve (LV), is one type of light modulator can be used to impress information equally across the entire beam (1D modulation), provide variation across the beam to form parallelized optical channels (2D modulation), or provide variations across a volume of pixels/voxels channels (3D modulation). The information imposed can be in the form of amplitude, phase, polarization, wavelength, coherency, or quantum entanglement. LVs can include electro-optical devices in which information is transferred onto an incoming optical field through application of a structured force onto a material that allows coupling between optical field and the structured force. Such devices can be composed of an electrical circuit which includes a transparent conductive oxide (TCO, to the incoming optical field, at λ1), a photoconductor (PC), and an electro-optical material (EOM). The TCO activates the photoconductor so that a structured force (usually in the form of a low energy/fluence optical field at wavelength λ2) is impressed onto the photoconductor as a spatially varying voltage that is then placed across the electro-optic material. The electro-optical material transfers this spatial information to the optical field through reaction with a spatially varying voltage. The optical field exits the device carrying the spatial information in one or more of the attributes listed above.

In some embodiments, laser beams can be patterned by blocking with masks with fixed or movable elements. To increase flexibility and ease of image patterning, pixel addressable masking, image generation, or transmission can be used. In some embodiments, the laser patterning unit includes addressable light valves, alone or in conjunction with other patterning mechanisms to provide patterning. The light valves can be transmissive, reflective, or use a combination of transmissive and reflective elements. Patterns can be dynamically modified using electrical or optical addressing. In one embodiment, a transmissive optically addressed light valve acts to rotate polarization of light passing through the valve, with optically addressed pixels forming patterns defined by a light projection source. In another embodiment, a reflective optically addressed light valve includes a write beam for modifying polarization of a read beam. In certain embodiments, non-optically addressed light valves can be used. These can include but are not limited to electrically addressable pixel elements, movable mirror or micro-mirror systems, piezo or micro-actuated optical systems, fixed or movable masks, or shields, or any other conventional system able to provide high intensity light patterning.

Target 150A can include materials or items suitable for subtractive, cutting or laser drilling, or additive processing. Metal, ceramic, plastic, polymeric materials, glasses, or other meltable materials can be used. In some embodiments useful in additive manufacturing, a target can be a metallic or ceramic powder that is supported by a powder bed. Various types of material can be distributed, removed, mixed, provide with gradations or changes in material type or particle size, or have layer thickness of material adjusted. The material can include metal, ceramic, glass, polymeric powders, other meltable material capable of undergoing a thermally induced phase change from solid to liquid and back again, or combinations thereof. The material can further include composites of meltable material and non-meltable material where either or both components can be selectively targeted to melt the component that is melt-able, while either leaving along the non-melt-able material or causing it to undergo a vaporizing/destroying/combusting or otherwise destructive process. In certain embodiments, slurries, sprays, coatings, wires, strips, or sheets of materials can be used.

FIG. 1B illustrates system 100B including speckle reduction system 110B using multiple lasers combined in a common fiber. Multiple laser sources 102B are used to inject laser light into a common fiber to decrease the effective coherence and lower the speckle contrast. Multiple (greater than or equal to two) laser sources 102B are launched into a fiber combiner 112B which couples to a single transport fiber 114B which launches into a laser amplifier system 120B. The output of the laser amplifier system 120B is directed to a laser homogenizer system 130B which creates an image at target 150C. In some embodiments, the laser can be directed through an area patterning system such as discussed with respect to FIG. 1A before being directed against the target 150C

In operation, multiple coherent diodes light sources are combined together through a multimode splitter. Each diode laser has a high temporal coherence length and produces a fixed number of modes that lead to the generation of speckle. By combining multiple diode laser sources together with different temporal coherence and central wavelengths, linewidth distribution of the pulse is broadened before amplification. Incoherent speckle patterns from multiple light sources sum during the pulse, reducing the effective speckle flux for each pulse of the laser. In some embodiments, core diameter is greater than 5-10 microns, with core diameter greater than 100 microns advantageously providing a large number of spatial modes serve to maximize effects of different mode propagation and coherence afforded to the different laser sources 102B.

FIG. 1C illustrates a system 100C including a speckle reduction system 110C using fiber splitters of differing length. A laser source 102C provides a laser beam launched into a fiber splitter 112C which couples to a multiple different lengths of fibers 113C. These fiber lengths can vary from 1 meter to 1 km or more but typically <20 m. These fibers 113C are combined in a fiber combiner and transported through a single transport fiber 114C to an amplifier system 120C. The output of the laser amplifier system 120C is directed to a laser homogenizer system 130C which creates an image at target 150C. In some embodiments, the laser can be directed through an area patterning system such as discussed with respect to FIG. 1A before being directed against the target 150C.

In operation, providing a different length fiber serves to offset the pulses temporally beyond their respective coherence length. This effectively lowers the speckle contrast.

FIG. 1D illustrates a system 100D including a speckle reduction system 110D using an RF modulator that adds spectral bandwidth to a laser pulse. A laser source 102D is launched into an RF modulator 112D that is either free space coupled or fiber based. This RF modulator 112D is driven by an RF oscillator 116D that is amplified by an RF amplifier 118D to provide sufficient phase modulation depth to achieve a desired spectral bandwidth in the RF phase modulator 112D. The required spectral bandwidth needed to achieve speckle reduction is system dependent but can vary from as little as 1 GHz (˜0.003 nm in the 1 micron near infrared spectrum) or as much as 300 GHz (˜1 nm in the same 1 micron near infrared spectrum). The output of the RF phase modulator 112D is transported through a single transport fiber 114D to a laser amplifier system 120D. The output of the laser amplifier system 120D is directed to a laser homogenizer system 130D which creates an image at target 150D. In some embodiments, the laser can be directed through an area patterning system such as discussed with respect to FIG. 1A before being directed against the target 150D.

In operation, the time-dependent wavelength propagates differently through fiber to create time-dependent speckle patterns. When summed over the laser pulse time an average or smoothed speckle contrast is provided.

FIG. 1E illustrates a system 100E including a speckle reduction system 110E using large area mode fibers that increase number of modes. A laser source 102E is launched into a transport fiber 114E and the laser preamplifier system 122E. The output of the preamplifier system 122E is launched into a very large mode area fiber 116E where the diameter of this fiber can range from 100 microns to 2000 microns with typical values used in the 500-1000 micron range. The output of the large mode fiber 116E is coupled into the main laser amplifier system 120E. The output of the laser amplifier system 120E is directed to a laser homogenizer system 130E which creates an image at target 150E. In some embodiments, the laser can be directed through an area patterning system such as discussed with respect to FIG. 1A before being directed against the target 150E.

In operation, use of large area mode fibers increase the number of modes. Advantageously, increasing modes results in speckle size reduction.

FIG. 1F illustrates a system 100F including a speckle reduction system 110F using an actuator to cause displacement of the multimode fiber. A laser source 102F is launched into a transport fiber 114F which is held in a block 112F driven by actuator 116F (including but not limited to piezo or ultrasonic actuator 116F) The actuator must be of sufficient amplitude and frequency to induce a mode change in the coil of transport fiber. An example of drive conditions sufficient for lasers of the type used for additive manufacturing would be frequencies in the range of 100 kHz-10 MHz, with amplitude in the range of 1-10 um. The transport fiber 114F is launched into the laser amplifier system 120F. The output of the laser amplifier system 120F is directed to a laser homogenizer system 130F which creates an image at target 150F. In some embodiments, the laser can be directed through an area patterning system such as discussed with respect to FIG. 1A before being directed against the target 150E.

In operation, use of actuator causes displacement of a fiber 114F. This in turn induces speckle pattern changes due to modification of mode paths through the fiber 114F.

FIG. 1G illustrates a system 100G including a speckle reduction system 110G using various optical and acoustic deflectors or modifiers to change speckle pattern. A laser source 102G is launched into a modulator 112G. This modulator 112G is driven by controller 116G. The output of the modulator 112G is transported through a single transport fiber 114G to a laser amplifier system 120G. The output of the laser amplifier system 120G is directed to a laser homogenizer system 130G which creates an image at target 150G. In some embodiments, the laser can be directed through an area patterning system such as discussed with respect to FIG. 1A before being directed against the target 150G.

Various types of modulator 112G with different operating characteristics can be used. For example, an acousto-optic deflector which changes the transmitted angle of the pulse as a function of time can act as modulator 112G. This angular deviation causes the speckle pattern to change on the downstream fiber system. Deflector parameters are chosen such that deflection of the beam occurs within the laser pulse length and with sufficient deflection to induce a change in the transported beam speckle pattern.

In another embodiment, modulator 112G uses a tunable acoustic gradient (TAG) lens which can change the launch conditions into a fiber as a function of time, consequently changing the speckle pattern. The controller 116G and lens capabilities must be sufficient to induce focal length changes of sufficient amplitude and in a short enough time to affect the laser pulse. For example, a 100 kHz-10 MHz with focal power changes of 1-10 diopters can be used.

In another embodiment, modulator 112G uses an electro optic deflector which changes the transmitted angle of the pulse as a function of time. This angular deviation causes the speckle pattern to change on the downstream fiber system. The controller 116G and deflector capabilities must be sufficient to induce deflection of sufficient amplitude and in a short enough time to affect the laser pulse. For example, suitable conditions would be 100 kHz-1 GHz with deflection of 8-90 mrad.

In another embodiment, modulator 112G uses a thermo optic deflector which changes the local refractive index of a waveguide to result in changes in transmitted angle of the pulse as a function of time. This angular deviation causes the speckle pattern to change. The light source and deflector capabilities must be selected to induce deflection of sufficient amplitude and in a short enough time to affect the laser pulse. For example, suitable conditions would be 100 W-2 kW with deflection of 8-180 mrad.

Speckle control such as described in the disclosure is useful in various applications and for various pulse format regimes. For example, pulse format regime ranging over 0.1-100 microseconds is advantageous for applications such as hole drilling where the peak power achieves melting of the material at lower net average power while at the same time operating in pulse regimes where plasma induced effects such as plasma mirrors are minimized.

In other embodiments, speckle reduction can be used when interacting with damage threshold sensitive optics, or when controlling the peak to average in an additive manufacturing system print bed to avoid print defects (i.e. under melting and over melting (boiling and/or plasma generation). Decreasing the peak to average improves the melt uniformity and therefore melt quality of printed materials. In some embodiments, speckle reduction is useful in conjunction with light valves to modulate large-scale speckle additive manufacture, a laser peening system, laser machining or other laser based targeting system where material is thermally modified at the target location and uniformity is desired. In some embodiments, a speckle reduction such as described herein can can be a component used to increase uniformity in systems that otherwise might have peak to average values of less than 2:1, 1.5:1, or 1.2:1.

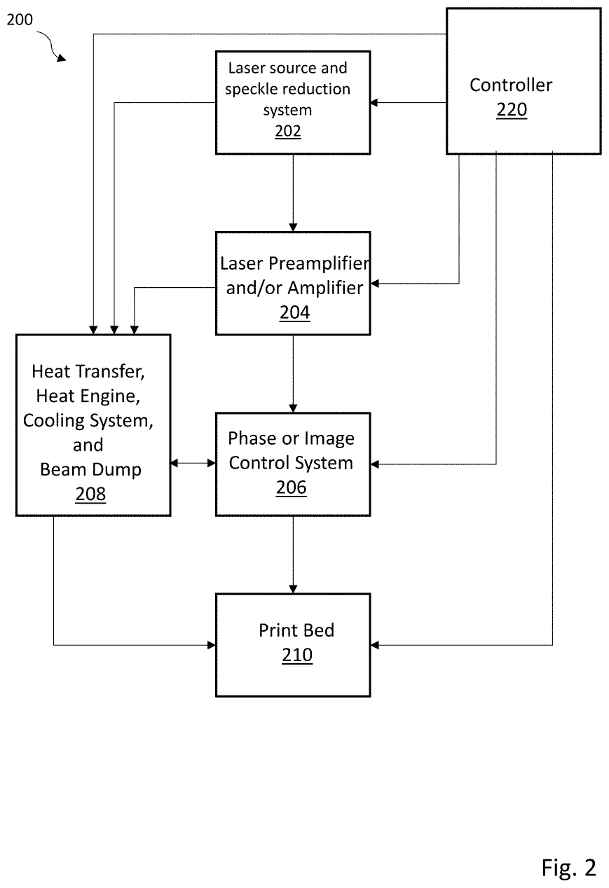

FIG. 2 illustrates use of an additive manufacturing system 200 including a speckle reduction system. In one embodiment, a laser source and speckle reduction system 202 directs a laser beam through a laser preamplifier and/or amplifier 204 into a phase control system 206 that can optionally include a spatial light valve. After phase patterning, light can be directed into a print bed 210. In some embodiments, heat or laser energy from laser source 202, laser preamplifier and/or amplifier 204, or phase control system 206 can be actively or passively transferred to a heat transfer, heat engine, cooling system, and beam dump 208. Overall operation of the light valve based additive manufacturing system 200 can controlled by one or more controllers 220 that can modify laser power and timing.

In some embodiments, thermal energy and laser energy generated during operation of system 200 can be directed into the heat transfer, heat engine, cooling system, and beam dump 208. Alternatively, or in addition, in some embodiments the beam dump 208 can be a part of a heat transfer system to provide useful heat to other industrial processes. In still other embodiments, the heat can be used to power a heat engine suitable for generating mechanical, thermoelectric, or electric power. In some embodiments, waste heat can be used to increase temperature of connected components. As will be appreciated, laser flux and energy can be scaled in this architecture by adding more pre-amplifiers and amplifiers with appropriate thermal management and optical isolation. Adjustments to heat removal characteristics of the cooling system are possible, with increase in pump rate or changing cooling efficiency being used to adjust performance.

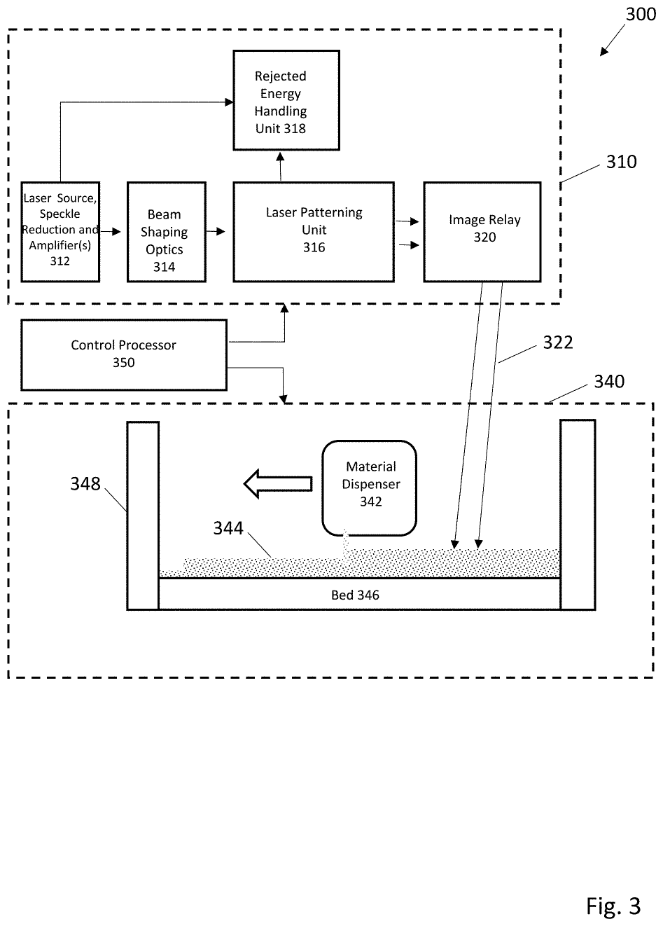

FIG. 3 illustrates an additive manufacturing system 300 including a speckle reduction system. As seen in FIG. 3, a laser source, speckle reduction system, and amplifier(s) 312 can include phase control systems, spatial light valves, and laser amplifiers and other components such as previously described. As illustrated in FIG. 3, the additive manufacturing system 300 uses lasers able to provide one or two dimensional directed energy as part of a laser patterning system 310. In some embodiments, phase patterns or holographic images can be directed. In other embodiments, one dimensional patterning can be directed as linear or curved strips, as rastered lines, as spiral lines, or in any other suitable form. Two or three-dimensional phase or image patterning embodiments are also possible, with use of separated or overlapping tiles, or images with variations in laser intensity. Two or three-dimensional phase or image patterns having non-square boundaries can be used, overlapping or interpenetrating images can be used, and images can be provided by two or more energy patterning systems. The laser patterning system 310 uses laser source and amplifier(s) 312 to direct one or more continuous or intermittent energy beam(s) toward beam shaping optics 314. After shaping, if necessary, the beam is patterned by a laser patterning unit 316 that can include either a transmissive or reflective light valve, with generally some energy being directed to a rejected energy handling unit 318. The rejected energy handling unit can utilize heat provided by active of cooling of light valves. Phase or image patterned energy is relayed by image relay 320 toward an article processing unit 340, in one embodiment as a two-dimensional image 322 focused near a bed 346. The bed 346 (with optional walls 348) can form a chamber containing material 344 (e.g. a metal powder) dispensed by material dispenser 342. Patterned energy, directed by the image relay 320, can melt, fuse, sinter, amalgamate, change crystal structure, influence stress patterns, or otherwise chemically or physically modify the dispensed material 344 to form structures with desired properties. A control processor 350 can be connected to variety of sensors, actuators, heating or cooling systems, monitors, and controllers to coordinate operation of the laser source and amplifier(s) 312, beam shaping optics 314, laser patterning unit 316, and image relay 320, as well as any other component of system 300. As will be appreciated, connections can be wired or wireless, continuous or intermittent, and include capability for feedback (for example, thermal heating can be adjusted in response to sensed temperature).

In some embodiments, beam shaping optics 314 can include a great variety of imaging optics to combine, focus, diverge, reflect, refract, homogenize, adjust intensity, adjust frequency, or otherwise shape and direct one or more laser beams received from the laser source and amplifier(s) 312 toward the laser patterning unit 316. In one embodiment, multiple light beams, each having a distinct light wavelength, can be combined using wavelength selective mirrors (e.g. dichroics) or diffractive elements. In other embodiments, multiple beams can be homogenized or combined using multifaceted mirrors, microlenses, and refractive or diffractive optical elements.

Laser patterning unit 316 can include phase, image, static or dynamic energy patterning elements. For example, laser beams can be blocked by masks with fixed or movable elements. To increase flexibility and ease of image patterning, pixel addressable masking, image generation, or transmission can be used. In some embodiments, the laser patterning unit includes addressable light valves, alone or in conjunction with other patterning mechanisms to provide patterning. The light valves can be transmissive, reflective, or use a combination of transmissive and reflective elements. Phase or image patterns can be dynamically modified using electrical or optical addressing. In one embodiment, a transmissive optically addressed light valve acts to rotate polarization of light passing through the valve, with optically addressed pixels forming patterns defined by a light projection source. In another embodiment, a reflective optically addressed light valve includes a write beam for modifying polarization of a read beam. In certain embodiments, non-optically addressed light valves can be used. These can include but are not limited to electrically addressable pixel elements, movable mirror or micro-mirror systems, piezo or micro-actuated optical systems, fixed or movable masks, or shields, or any other conventional system able to provide high intensity light patterning.

Rejected energy handling unit 318 is used to disperse, redirect, or utilize energy not patterned and passed through the image relay 320. In one embodiment, the rejected energy handling unit 318 can include passive or active cooling elements that remove heat from both the laser source, light valve(s), and amplifier(s) 312 and the laser patterning unit 316. In other embodiments, the rejected energy handling unit can include a “beam dump” to absorb and convert to heat any beam energy not used in defining the laser pattern. In still other embodiments, rejected laser beam energy can be recycled using beam shaping optics 314. Alternatively, or in addition, rejected beam energy can be directed to the article processing unit 340 for heating or further patterning. In certain embodiments, rejected beam energy can be directed to additional energy patterning systems or article processing units.

In one embodiment, a “switchyard” style optical system can be used. Switchyard systems are suitable for reducing the light wasted in the additive manufacturing system as caused by rejection of unwanted light due to the pattern to be printed. A switchyard involves redirections of a complex pattern from its generation (in this case, a plane whereupon a spatial pattern is imparted to structured or unstructured beam) to its delivery through a series of switch points. Each switch point can optionally modify the spatial profile of the incident beam. The switchyard optical system may be utilized in, for example and not limited to, laser-based additive manufacturing techniques where a mask is applied to the light. Advantageously, in various embodiments in accordance with the present disclosure, the thrown-away energy may be recycled in either a homogenized form or as a patterned light that is used to maintain high power efficiency or high throughput rates. Moreover, the thrown-away energy can be recycled and reused to increase intensity to print more difficult materials.

Image relay 320 can receive a patterned image (either one or two-dimensional) from the laser patterning unit 316 directly or through a switchyard and guide it toward the article processing unit 340. In a manner similar to beam shaping optics 314, the image relay 320 can include optics to combine, focus, diverge, reflect, refract, adjust intensity, adjust frequency, or otherwise shape and direct the patterned light. Patterned light can be directed using movable mirrors, prisms, diffractive optical elements, or solid state optical systems that do not require substantial physical movement. One of a plurality of lens assemblies can be configured to provide the incident light having the magnification ratio, with the lens assemblies both a first set of optical lenses and a second sets of optical lenses, and with the second sets of optical lenses being swappable from the lens assemblies. Rotations of one or more sets of mirrors mounted on compensating gantries and a final mirror mounted on a build platform gantry can be used to direct the incident light from a precursor mirror onto a desired location. Translational movements of compensating gantries and the build platform gantry are also able to ensure that distance of the incident light from the precursor mirror the article processing unit 340 is substantially equivalent to the image distance. In effect, this enables a quick change in the optical beam delivery size and intensity across locations of a build area for different materials while ensuring high availability of the system.

Article processing unit 340 can include a walled chamber 348 and bed 344 (collectively defining a build chamber), and a material dispenser 342 for distributing material. The material dispenser 342 can distribute, remove, mix, provide gradations or changes in material type or particle size, or adjust layer thickness of material. The material can include metal, ceramic, glass, polymeric powders, other melt-able material capable of undergoing a thermally induced phase change from solid to liquid and back again, or combinations thereof. The material can further include composites of meltable material and non-melt-able material where either or both components can be selectively targeted by the imaging relay system to melt the component that is meltable, while either leaving along the non-melt-able material or causing it to undergo a vaporizing/destroying/combusting or otherwise destructive process. In certain embodiments, slurries, sprays, coatings, wires, strips, or sheets of materials can be used. Unwanted material can be removed for disposable or recycling by use of blowers, vacuum systems, sweeping, vibrating, shaking, tipping, or inversion of the bed 346.

In addition to material handling components, the article processing unit 340 can include components for holding and supporting 3D structures, mechanisms for heating or cooling the chamber, auxiliary or supporting optics, and sensors and control mechanisms for monitoring or adjusting material or environmental conditions. The article processing unit can, in whole or in part, support a vacuum or inert gas atmosphere to reduce unwanted chemical interactions as well as to mitigate the risks of fire or explosion (especially with reactive metals). In some embodiments, various pure or mixtures of other atmospheres can be used, including those containing Ar, He, Ne, Kr, Xe, CO₂, N₂, O₂, SF₆, CH₄, CO, N₂O, C₂H₂, C₂H₄, C₂H₆, C₃H₆, C₃H₈, i-C₄H₁₀, C₄H₁₀, 1-C₄H₈, cic-2,C₄H₇, 1,3-C₄H₆, 1,2-C₄H₆, C₅H₁₂, n-C₅H₁₂, i-C₅H₁₂, n-C₆H₁₄, C₂H₃Cl, C₇H₁₆, C₈H₁₈, C₁₀H₂₂, C₁₁H₂₄, C₁₂H₂₆, C₁₃H₂₈, C₁₄H₃₀, C₁₅H₃₂, C₁₆H₃₄, C₆H₆, C₆H₅-CH₃, C₈H₁₀, C₂H₅OH, CH₃OH, iC₄H₈. In some embodiments, refrigerants or large inert molecules (including but not limited to sulfur hexafluoride) can be used. An enclosure atmospheric composition to have at least about 1% He by volume (or number density), along with selected percentages of inert/non-reactive gasses can be used.

In certain embodiments, a plurality of article processing units or build chambers, each having a build platform to hold a powder bed, can be used in conjunction with multiple optical-mechanical assemblies arranged to receive and direct the one or more incident energy beams into the build chambers. Multiple chambers allow for concurrent printing of one or more print jobs inside one or more build chambers. In other embodiments, a removable chamber sidewall can simplify removal of printed objects from build chambers, allowing quick exchanges of powdered materials. The chamber can also be equipped with an adjustable process temperature controls. In still other embodiments, a build chamber can be configured as a removable printer cartridge positionable near laser optics. In some embodiments a removable printer cartridge can include powder or support detachable connections to a powder supply. After manufacture of an item, a removable printer cartridge can be removed and replaced with a fresh printer cartridge.

In another embodiment, one or more article processing units or build chambers can have a build chamber that is maintained at a fixed height, while optics are vertically movable. A distance between final optics of a lens assembly and a top surface of powder bed a may be managed to be essentially constant by indexing final optics upwards, by a distance equivalent to a thickness of a powder layer, while keeping the build platform at a fixed height. Advantageously, as compared to a vertically moving the build platform, large and heavy objects can be more easily manufactured, since precise micron scale movements of the ever changing mass of the build platform are not needed. Typically, build chambers intended for metal powders with a volume more than ˜0.1-0.2 cubic meters (i.e., greater than 100-200 liters or heavier than 500-1,000 kg) will most benefit from keeping the build platform at a fixed height.

In one embodiment, a portion of the layer of the powder bed may be selectively melted or fused to form one or more temporary walls out of the fused portion of the layer of the powder bed to contain another portion of the layer of the powder bed on the build platform. In selected embodiments, a fluid passageway can be formed in the one or more first walls to enable improved thermal management.

In some embodiments, the additive manufacturing system can include article processing units or build chambers with a build platform that supports a powder bed capable of tilting, inverting, and shaking to separate the powder bed substantially from the build platform in a hopper. The powdered material forming the powder bed may be collected in a hopper for reuse in later print jobs. The powder collecting process may be automated and vacuuming or gas jet systems also used to aid powder dislodgement and removal.

In some embodiments, the additive manufacturing system can be configured to easily handle parts longer than an available build chamber. A continuous (long) part can be sequentially advanced in a longitudinal direction from a first zone to a second zone. In the first zone, selected granules of a granular material can be amalgamated. In the second zone, unamalgamated granules of the granular material can be removed. The first portion of the continuous part can be advanced from the second zone to a third zone, while a last portion of the continuous part is formed within the first zone and the first portion is maintained in the same position in the lateral and transverse directions that the first portion occupied within the first zone and the second zone. In effect, additive manufacture and clean-up (e.g., separation and/or reclamation of unused or unamalgamated granular material) may be performed in parallel (i.e., at the same time) at different locations or zones on a part conveyor, with no need to stop for removal of granular material and/or parts.

In another embodiment, additive manufacturing capability can be improved by use of an enclosure restricting an exchange of gaseous matter between an interior of the enclosure and an exterior of the enclosure. An airlock provides an interface between the interior and the exterior; with the interior having multiple additive manufacturing chambers, including those supporting power bed fusion. A gas management system maintains gaseous oxygen within the interior at or below a limiting oxygen concentration, increasing flexibility in types of powder and processing that can be used in the system.

In another manufacturing embodiment, capability can be improved by having an article processing units or build chamber contained within an enclosure, the build chamber being able to create a part having a weight greater than or equal to 2,000 kilograms. A gas management system may maintain gaseous oxygen within the enclosure at concentrations below the atmospheric level. In some embodiments, a wheeled vehicle may transport the part from inside the enclosure, through an airlock, since the airlock operates to buffer between a gaseous environment within the enclosure and a gaseous environment outside the enclosure, and to a location exterior to both the enclosure and the airlock.

Other manufacturing embodiments involve collecting powder samples in real-time from the powder bed. An ingester system is used for in-process collection and characterizations of powder samples. The collection may be performed periodically and the results of characterizations result in adjustments to the powder bed fusion process. The ingester system can optionally be used for one or more of audit, process adjustments or actions such as modifying printer parameters or verifying proper use of licensed powder materials.

Yet another improvement to an additive manufacturing process can be provided by use of a manipulator device such as a crane, lifting gantry, robot arm, or similar that allows for the manipulation of parts that would be difficult or impossible for a human to move is described. The manipulator device can grasp various permanent or temporary additively manufactured manipulation points on a part to enable repositioning or maneuvering of the part.

Control processor 350 can be connected to control any components of additive manufacturing system 300 described herein, including lasers, laser amplifiers, optics, heat control, build chambers, and manipulator devices. The control processor 350 can be connected to variety of sensors, actuators, heating or cooling systems, monitors, and controllers to coordinate operation. A wide range of sensors, including imagers, light intensity monitors, thermal, pressure, or gas sensors can be used to provide information used in control or monitoring. The control processor can be a single central controller, or alternatively, can include one or more independent control systems. The controller processor 350 is provided with an interface to allow input of manufacturing instructions. Use of a wide range of sensors allows various feedback control mechanisms that improve quality, manufacturing throughput, and energy efficiency.

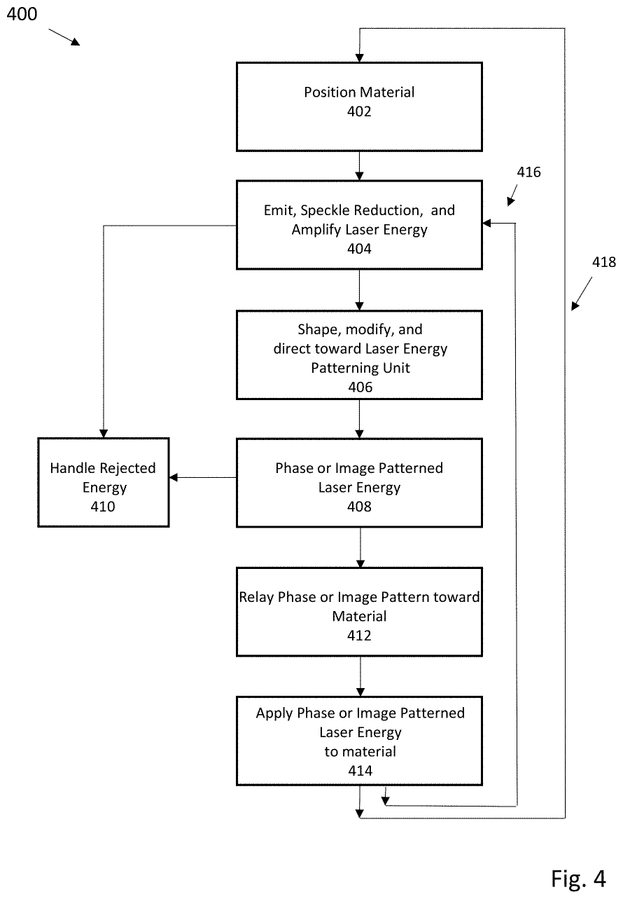

One embodiment of operation of a manufacturing system supporting use of a phase patterned laser energy suitable for additive or subtractive manufacture is illustrated in FIG. 4. In this embodiment, a flow chart 400 illustrates one embodiment of a manufacturing process supported by the described optical and mechanical components. In step 402, material is positioned in a bed, chamber, or other suitable support. The material can be a metal plate for laser cutting using subtractive manufacture techniques, or a powder capable of being melted, fused, sintered, induced to change crystal structure, have stress patterns influenced, or otherwise chemically or physically modified by additive manufacturing techniques to form structures with desired properties.

In step 404, unpatterned laser energy is emitted by one or more energy emitters, including but not limited to solid state or semiconductor lasers, passed through a speckle reduction system, and then amplified by one or more laser amplifiers. In step 406, the unpatterned laser energy is shaped and modified (e.g. intensity modulated or focused). In step 408, this unpatterned laser energy is patterned by a phase patterning unit, which can include optional use of a light valve, with energy not forming a part of the phase or image pattern being handled in step 410 (this can include use of a beam dump as disclosed with respect to FIG. 2 and FIG. 3 that provide conversion to waste heat, recycling as patterned or unpatterned energy, or waste heat generated by cooling the laser amplifiers in step 404). In step 412, the patterned energy, now forming a one or two-dimensional image is relayed toward the material. In step 414, the image is applied to the material, either subtractively processing or additively building a portion of a 3D structure. For additive manufacturing, these steps can be repeated (loop 416) until the image (or different and subsequent image) has been applied to all necessary regions of a top layer of the material. When application of energy to the top layer of the material is finished, a new layer can be applied (loop 418) to continue building the 3D structure. These process loops are continued until the 3D structure is complete, when remaining excess material can be removed or recycled.

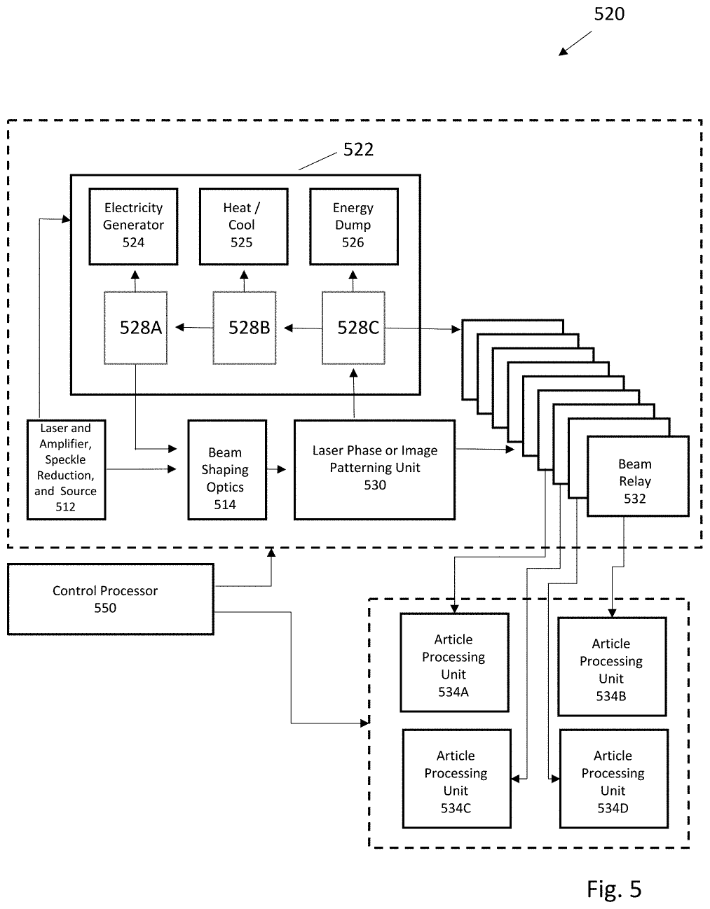

FIG. 5 is one embodiment of an additive manufacturing system that includes a phase and/or image patterning unit and a switchyard system enabling reuse of phase or image patterned two-dimensional energy. An additive manufacturing system 520 has an energy patterning system with a laser, speckle reduction system, and amplifier source 512 that directs one or more continuous or intermittent laser beam(s) toward beam shaping optics 514. Excess heat can be transferred into a rejected energy handling unit 522. After shaping, the beam is two-dimensionally patterned by a laser phase patterning unit 530, with generally some energy being directed to the rejected energy handling unit 522. Patterned energy is relayed by one of multiple image relays 532 toward one or more article processing units 534A, 534B, 534C, or 534D, typically as a two-dimensional image focused near a movable or fixed height bed. The bed can be inside a cartridge that includes a powder hopper or similar material dispenser. Patterned laser beams, directed by the image relays 532, can melt, fuse, sinter, amalgamate, change crystal structure, influence stress patterns, or otherwise chemically or physically modify the dispensed material to form structures with desired properties.

In this embodiment, the rejected energy handling unit has multiple components to permit reuse of rejected patterned energy. Coolant fluid from the laser amplifier and source 512 can be directed into one or more of an electricity generator 524, a heat/cool thermal management system 525, or an energy dump 526. Additionally, relays 528A, 528B, and 528C can respectively transfer energy to the electricity generator 524, the heat/cool thermal management system 525, or the energy dump 526. Optionally, relay 528C can direct patterned energy into the image relay 532 for further processing. In other embodiments, patterned energy can be directed by relay 528C, to relay 528B and 528A for insertion into the laser beam(s) provided by laser and amplifier source 512. Reuse of patterned images is also possible using image relay 532. Images can be redirected, inverted, mirrored, sub-patterned, or otherwise transformed for distribution to one or more article processing units. 534A-D. Advantageously, reuse of the patterned light can improve energy efficiency of the additive manufacturing process, and in some cases improve energy intensity directed at a bed or reduce manufacture time.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims. It is also understood that other embodiments of this invention may be practiced in the absence of an element/step not specifically disclosed herein.

1. An additive manufacturing system, comprising:
at least one laser source;
a speckle reduction system that receives light from the at least one laser source;
an optical homogenizer that increases uniformity of laser light received from the speckle reduction system; and
an area patterning system that receives laser light directed through the optical homogenizer.

2. The additive manufacturing system of claim 1, wherein the speckle reduction system includes multiple lasers combined in a common fiber.

3. The additive manufacturing system of claim 1, wherein the speckle reduction system includes fiber splitters of differing length.

4. The additive manufacturing system of claim 1, wherein the speckle reduction system includes an RF modulator that adds spectral bandwidth to a laser pulse.

5. The additive manufacturing system of claim 1, wherein the speckle reduction system includes large area mode fibers that increase number of modes.

6. The additive manufacturing system of claim 1, wherein the speckle reduction system includes an actuator to cause displacement of the multimode fiber.

8. The additive manufacturing system of claim 1, wherein the speckle reduction system includes an acousto-optic deflector.

7. The additive manufacturing system of claim 1, wherein the speckle reduction system includes a tunable acoustic gradient (TAG) lens.

9. The additive manufacturing system of claim 1, wherein the speckle reduction system includes electro optic deflector.

10. The additive manufacturing system of claim 1, wherein the speckle reduction system includes a thermo optic deflector.

11. The additive manufacturing system of claim 1, wherein the additive manufacturing system further comprises a spatial light valve.

12. The additive manufacturing system of claim 1, wherein the additive manufacturing further comprises a plurality of beam relays for directing lasers against multiple targets.
